(19) United States
(12) Patent Application Publication
(10) Pub. No.: US 2012/0191423 A1
(43) Pub. Date: Jul. 26, 2012

(54) METHOD FOR LOCAL REFINEMENT OF GEOMETRIC OR PHYSICAL REPRESENTATION

(76) Inventors: Tor Dokken, Oslo (NO); Tom Lyche, Oslo (NO); Vibeke Skytt, Haslum (NO); Kjell Fredrik Pettersen, Jar (NO)

(21) Appl. No.: 13/390,180

(22) PCT Filed: Aug. 26, 2010
(86) PCT No.: PCT/NO10/00317

§ 371 Date: Apr. 9, 2012

Related U.S. Application Data
(60) Provisional application No. 61/237,024, filed on Aug. 26, 2009.

(51) Int. Cl. G06F 17/50

(52) U.S. Cl. 703/1

(57) ABSTRACT

The invention provides a method for spatially refining a computer generated l-dimensional (l>0) model in a computing environment, the l-dimensional model representing physical or geometrical properties, and where the l-dimensional model is represented by tensor product B-splines basis functions and l-dimensional coefficients, where the l-dimensional coefficients are in real or projective space, and the tensor product B-splines basis functions are spanning an r-variate spline space (r>0) having a parameter domain, the method comprising: a) inserting at least one axis parallel hyper rectangle degenerate in one dimension in said parameter domain, providing a splitting of a support of at least one of said tensor product B-spline basis functions; b) computing refined tensor product B-spline basis functions by subdivision on said at least one tensor product B-splines basis functions whose support is split, using at least one knot value of the at least one axis parallel hyper rectangle; and c) computing the resulting refined l-dimensional representation based on said refined tensor product B-spline basis functions.

### INTRODUCTION

The present invention concerns computer generated models representing physical or geometric properties, and in particular a method for local refinement of a computer generated l-dimensional (l>0) model in a computing environment.

### BACKGROUND

In Computer Aided Design (CAD) elementary shapes such as circle, ellipse, cylinder, and cone are represented with specific formats, while free form curves and sculptured surfaces are represented by NonUniform Rational B-splines (NURBS). The NURBS representation can also be used for exact representation of elementary shapes, however, when converting the elementary shapes to NURBS much design intent is lost.

Within Finite Element Analysis (FEA) the shape of the geometry is represented by structures of Finite Elements. The shape of Finite Elements is described by one multi-variate polynomial, or by a number of multi-variate polynomials in case of composite elements. The total shape of the object is described by structures of Finite Elements joined with low order continuity. Frequently within Finite Element Analysis the order of continuity between elements is as low as C⁰. However, C¹ continuity between elements is not uncommon.

While the CAD offers accurate shape description, the shape representation in FEA is a simplification of the real object shape.

Within CAD refinement of NURBS represented surfaces is necessary to offer better shape modeling tools to the designer, and for stitching adjacent NURBS-surfaces together to larger surfaces. The Oslo Algorithm from 1980 introduced refinement of univariate B-spline functions. However, as NURBS surfaces are described by tensor products of univariate B-spline spaces, the refinement has global effects. E.g., when refining a B-spline surface with 100×100 coefficients the minimal increase in the number of coefficients is 100. Such a refinement follows the tensor product structure of the surface, and thus crosses the surface from one side to the other giving a global effect of the refinement.

Within FEA refinement is necessary to adapt the degrees of freedom to the problem at hand, e.g., based on error estimators of a prior analysis result.

In 1988 Forsey (D. R. Forsey and R. H. Barrels, Hierarchical B-Spline Refinement, Computer Graphics, Volume 22, Number 4, August 1988) introduced hierarchal B-splines where a function was represented by a sum of progressively refined tensor product B-spline spaces. The impact of the innovation was less than expected probably due to the multi-level coding of the representation, and the lack of a linear independent bases. The challenges of linear independence were solved in 1998 in the PhD thesis of Kraft (R. Kraft, Adaptive und linear unabhängige multilevel B-splines und ihre Anwendungen. PhD thesis, Math Inst A, University of Stuttgatt, 1998). Also this work had little impact as the thesis was written in German. The coding of the hierarchal B-splines of Forsey and Kraft is by hierarchical structures of rectangular regions in the domain of the spline function. Kraft removes linearly dependent basis functions at the coarser levels of the hierarchy to maintain linear independence of the basis, the coding through rectangular regions give the refinement a much wider footprint than is necessary When Sederberg introduced the C² bicubic T-splines in 2003 (T. W. Sederberg, J. Zheng, A. Bakenov., and A. Nasri, T-splines and T-NURCCS. ACM Transactions on Graphics 22, (2003), pp-477-484) the impact was significantly higher due to its direct geometric interpretation, and the focus on surface stitching and shape design. The innovation of T-splines is the one level coding of the refinement in the grid of control points (vertices). T-splines allow local refinements through introducing T-junctions in the spline surface control grid. The T-splines control grid can be regarded a generalization of the B-spline control grid, as T-splines provide local refinement of the spline control grid by introducing T-junctions. For T-splines the coding is done directly in the control grid. However, as the B-spline basis functions are deducted from the control grid, a set of rules are introduced to provide consistency. The consequence of these rules are that additional vertices frequently have to be inserting giving the T-spline refinement an nonsymmetrical behavior and a larger spatial footprint than needed.

Vertex insertion according to the T-spline method is shown in FIGS. 1a-d. Four stages of the refinement process are shown. In FIG. 1a) the surface vertex grid of a B-spline surface is seen to the left and the corresponding regular knot line grid of a B-spline is shown to the right. In FIG. 1b) one vertex is inserted in the picture to the left, and we see to the right the resulting knot line structure. In FIG. 1c) one additional surface vertex is shown inserted in the vertex grid, and to the right the desired but not possible knot segment structure is shown. This structure is prohibited by the T-spline rules for knot insertion. These rules dictate that 3 additional vertices have to be inserted. In d) we show the mandatory vertices to the left, and the resulting knot line structure to the right. FIG. 1d, also illustrates that refinement in two parameter directions by the T-spline approach introduces many more control points than desired, and that it is not symmetrical. When repeated refinements are performed this will often give an unwanted growth in the is bulk of the model representation. The T-spline approach is described in detail in U.S. Pat. No. 7,274,364 as is hereby incorporated by reference. U.S. Pat. No. 7,274,364, “System and method for defining T-spline and T-NURCC surfaces using local refinements”, addresses the steps from creating the T-mesh and necessary algorithms for computer implementation of the T-spline concept for surfaces.

NURBS based isogeometric analysis introduced in 2005 by Prof. Tom Hughes has been shown to be very advantageous compared to traditional finite elements representation with respect to convergence of the analysis and accuracy of results for many example cases. The superiority of the NURBS representation stems from the ability to represent desired continuity between polynomial segments (elements) explicitly in the basis function, the flexibility of polynomial degrees, stable numerical algorithms, and the partition of unity property of the basis functions. However, in isogeometric analysis local refinement of the solution space is frequently necessary to add additional degrees of freedom in regions of the analysis model where error estimates indicates that the solution is not sufficiently accurate. Refinement of a NURBS model by knot insertion has, as already mentioned, a global effect making the bulk of the model grow drastically, and making B-spline refinement too resource consuming for isogeometric analysis. However, as T-splines provide local refinements, they are superior to B-splines with respect to isogeometric analysis. This method is presented in US 20090024370, Method and System for Performing T-Spline Based Isogeometric Analysis, and is hereby incorporated by reference.

The prior art of T-splines provides coding of the local refinement in the control grid coefficients. The spline spaces are derived from the T-grid. Consequently the control of the spline space is indirect. Isogeometric analysis requires good control of the structure of the spline space combined with stable and efficient algorithms. The algorithms for T-splines is currently provided for the cubic case, and extensions to all odd polynomial degrees seem straight forward, however for T-splines there is little mathematical theory developed. The extensions of T-splines to even polynomial degrees are still an open question. It has also been shown that the basis for the accompanying spline space in some cases has linearly is dependent basis functions, and that the growth of coefficients in certain cases is near global. It should also be noted that T-splines refinement is not symmetric as for T-splines the sequence of insertions influence the topology of the resulting splines space as illustrated in FIG. 1. Although it has been stated that rules for volumetric T-splines are straight forward to deduct, these are not readily available and are expected to have the same deficiencies as T-splines for surfaces. Thus T-splines are not optimal for use in isogeometric analysis.

The above short comings have a direct influence on the representation of large spline based models as the representation of local features requires refinement of the spline space with a considerably larger footprint, than expected and necessary. The consequence is that the bulk of the spline representation is considerably larger than what is feasible and the models grow too bulky for many uses. The data processing of prior art models will for some large models not be possible due to the global effects of knot insertion or the large footprint of the local spline space refinement. In cases when it can be performed by a computer, the cost of the analysis will in many cases be too high to be feasible or the problem will be practically unsolvable as the models grow too big, and the demand for memory for model representation and demand for computational performance grow too large and is too expensive.

### SUMMARY OF THE INVENTION

The invention provides a solution to the problems presented above.

In a first aspect the invention provides a method for spatially refining a computer generated l-dimensional (l>0) model in a computing environment, the l-dimensional model representing physical or geometrical properties, and where the l-dimensional model is represented by tensor product B-splines basis functions and l-dimensional coefficients, where the l-dimensional coefficients are in real or projective space, and the tensor product B-splines basis functions are spanning an r-variate spline space (r>0) having a parameter domain, the method comprising:

a) inserting at least one axis parallel hyper rectangle degenerate in one dimension in said parameter domain, providing a splitting of a support of at least one of said tensor product B-spline basis functions;
b) computing refined tensor product B-spline basis functions by subdivision on said at least one tensor product B-splines basis functions whose support is split, using at least one knot value of the at least one axis parallel hyper rectangle; and
c) computing the resulting refined l-dimensional representation based on said refined tensor product B-spline basis functions.

Further refining of said refined l-dimensional r-variate representation may be performed by computing further refined tensor product B-spline basis functions by performing the steps a), b) and c) on the resulting refined l-dimensional representation.

In an embodiment, the method may further comprise computing an accumulated refinement specification based on the refined tensor product B-spline basis functions. Further subdivision of the refined tensor product B-spline basis functions may be performed by using the accumulated refinement specification for the refined basis functions which domain can be further refined by the accumulated refinement specification.

The axis parallel hyper rectangle with one dimension degenerate may be defined by two r-tuples of real values defining external corners of the axis parallel hyper rectangle, (r>0). The two r-tuples of real values may be specified by predefined knot vectors in all r-parameter directions of said domain.

Further, degree elevation may be performed on selected tensor product B-spline basis function.

The subdivided tensor product B-spline basis functions may be scaled by accumulated weights providing a partition of unity basis. Rationally scaling the subdivided tensor product B-spline basis functions may be performed by dividing by a sum of all tensor product B spline basis functions to provide a partition of unity basis.

The insertion of an axis parallel hyper rectangle according to the invention, results in the splitting of the support of at least one tensor product B-splines basis functions. The splitting of the support provides the dimensions in which to subdivide as the degenerate dimension. The knot value to be used in the subdivision is provided by the coincident coordinate values in the degenerate dimension of the two corners specifying the hyper rectangle.

The present innovation provides an approach in which the refinement of the rational spline represented model is performed by directly refining the spline space used in the representation by specifying regions in the spline space to be refined, the refinement type to be performed and the refinement parameters. The resulting spline space can be further refined.

The present innovation provides local spatial refinement (in FEA frequently denoted h-refinement) for spline represented shape and isogeometric analysis models. It also opens up the possibility for local degree elevation (in FEA frequently denoted p-refinement), and the combination of h- and p-refinement into what in isogeometric analysis is denoted k-refinement.

For all refinements types it is essential that the refined spline space has the spline space that existed before the refinement as a subspace. This means all models that could be represented before the refinement took place can be exactly represented after the refinement.

Consequently, the present invention provides an approach where the desired properties of the spline space are directly modeled, and the vertex grid is derived from the spline space itself. This is opposed to T-splines where the spline space is derived from the vertex grid.

The method according to the present invention directly addresses the structure of the spline space and focuses on approaches giving the refinement a minimal footprint in the parameter domain. The method is general in the sense that it is applicable to r-variate spline spaces (r>0), it is symmetric in the sense that the sequence of the refinement does not influence the result if the sequence of two refinement steps can be swapped, and it is valid for any polynomial degree.

The invention may, e.g., be used in:
Representation of shape in Computer Aided Design systems by providing local refinement for NonUniform Rational Spline Surfaces (NURBS).
In the modeling of terrain by allowing the granularity of the splines space used for the representation to be adapted to actual variations in the terrain.
For the modeling of geological structures by splines by allowing the volumetric representation of the structures to adapt to the actual complexity of the geological shape. The approach allows model blocks of at different levels of refinement and the mortar elements gluing them to be represented as one spline model.
For the use in partial differential equations based simulations systems for providing a significantly improved adaptive refinement technology both in geometrical shape representation and the simulation model.

The local nature of the refinement is also well suited for parallelization on homogeneous and heterogeneous parallel computational resources, such a multi core CPUs and parallel computers. The invention may be realized e.g. as software running in a computer having a graphics system. E.g. a computer system for CAD or visual modeling of physical structures/data.

We present an approach that we denote, Locally Refined Splines (LR-Splines), that directly models the locally refined spline space using tensor product B-spline basis functions. So rather than having a tensor product B-spline space generated by a tensor product of univariate B-spline spaces, we have a spline space spanned by a sum of tensor product B-spline basis functions. Each tensor product basis function is explicitly represented by its own local knot vectors. The knot vectors of the different basis functions are related through (repeated) basis function specific knot insertion starting from a traditional tensor product B-spline spaced. As the complete spline space can include many levels of refinement, partition of unity is ensured by assigning positive weights to the refined B-spline basis functions. The weights are generated by repeated use of known knot insertion algorithms (e.g. the Oslo Algorithm). The coding of the structure of tensor product B-spline basis functions will consequently be a hierarchical structure of tensor product B-spline basis functions. This scaling by weights is advantageous compared to the rational scaling used in T-splines to ensure the partition of unity property of the refined basis. Rational basis functions resulting from rational scaling are computationally more expensive when calculating values and derivatives, as a denominator is added. LR-spline can also be formulated using rational scaling and thus a variant of LR-splines can be made that include T-splines as a special case.

The present invention LR-Splines, are better suited for isogeometric analysis than tensor product B-splines and T-splines since the spline space can be tailored to the specific needs of an actual analysis. The present invention further provides an alternative to T-splines for solving the surface stitching problem. Modeling of surfaces by local insertion of vertices according to the T-spline idea is also supported. LR-Splines has also applications within 3D animation and within modeling of objects from measurements, both for 3D objects, objects in the real world, and models built from measured physical properties; e.g. hydrocarbon reservoir models built from seismic data.

In traditional hierarchical B-spline representation, the manifold (object) is composed of a sum of B-spline represented manifolds (objects) each spanned by more and more refined tensor product B-spline bases, thus providing a multi-level coding of the object. T-splines represent an alternative one level coding for hierarchical B-spline surfaces through the use of a T-grid. T-splines are not readily extendable to higher dimensional manifolds, and the spline space of T-splines is implicitly defined by the T-grid and a set of rules. The present invention is distinguished from T-splines by explicitly representing the spline space, and by refining selected tensor product B-spline basis functions. It has no restriction to the tensor product B-spline basis functions being 2-variate, and LR-Splines tensor product basis functions can be r-variate, r>0. The coefficients to be multiplied by the more or less refined tensor product basis functions are all on the same level, thus using a one level coding of coefficients similar to the approach of T-splines.

To handle the different level of refinement of the tensor product basis functions of LR-Splines, the basis functions are represented or coded in a hierarchical structure. Weights are introduced for scaling basis functions to ensure that the basis maintains the partition of unity property. The resulting basis is thus composed of scaled tensor product B-spline basis functions. The basis is globally linearly independent. However, within knot intervals the basis functions may be linearly dependent. This is due to the fact that the approach allows basis functions to ignore knots partially within its support. Traditional approaches for using B-splines do not allow this, and will demand refinement of such B-spline basis functions, a refinement that for LR-splines is not necessary.

### BRIEF DESCRIPTION OF DRAWINGS

Example embodiments of the invention will now be described with reference to the followings drawings, where:

FIG. 1 (prior art) shows refinement of a B-spline surface by local vertex insertion according to the T-spline method and rules. Four stages of the refinement process are displayed. In FIG. 1a) we see the surface vertices to the left and the corresponding regular knot line grid of a B-splines to the right. In FIG. 1b) one vertex is inserted in the vertex grid to the left, and we see to the right the resulting knot line structure. In FIG. 1c) on additional surface vertex is inserted, and to the right the desired but not possible knot segment structure. In FIG. 1d) we show to the left that 3 additional surface vertices have to be inserted according to the T-spline rules, and the resulting knot line structure is shown to the right.

FIG. 2a-2c (embodiment of the invention). In LR-spline refinement for 2-manifolds (surfaces) the refinement is performed with knot line segments and then the vertex grid of the spline surface is deducted from the resulting spline space. This example starts from the same configuration as in FIG. 1, and a B-splines surface and its regular grid of control lines is shown in FIG. 2a. In FIG. 2b we insert a knot line segment in the figure to the left, and a vertex is generated to the right. In FIG. 2c we insert an additional knot line segment splitting the vertex generated in the previous step into two. The knot lines in FIG. 2c) shows a refinement not allowed in the T-spline approach. The T-spline approach generated a knot line segment spanning 3 extra cells.

FIG. 3a-3b illustrates refinement of a tensor product B-spline spline space by inserting a minimal knot line segment in a bi-cubic B-spline surface according to an embodiment of the invention. In FIG. 3a a knot line segment is inserted and the figures from left to right show the support (darker area) of tensor product B-spline basis functions to be split by the inserted knot line segment. FIG. 3b shows the support (darker area) of the tensor product B-spline basis functions resulting from the knot line insertion.

FIG. 4a-4b illustrates a a refinement in the second parameter direction according to an embodiment of the invention. In FIG. 4a) the figures from left to right show the support (dark area) of the basis functions from FIG. 3b) that are split by the new knot line segment. In FIG. 4b) the figures from left to right show the support of the basis functions (dark area) resulting from the splitting operation.

FIG. 5 is a flow chart of spatial refinement of the LR-spline function according to an embodiment of the invention. The LR-spline function ƒₙ(x)= [symbol] cᵢⁿγᵢⁿBᵢ(x) is based on the refinement specification [symbol] ₙ₊₁ to make the refined LR-spline ƒₙ₊₁(x)= [symbol] cᵢⁿγᵢⁿBᵢ(x). The algorithms combines the new refinement [symbol] ₙ₊₁ with the accumulation of earlier refinements [symbol] ₙ= [symbol] ₁∪ . . . ∪ [symbol] ₙ to make a new accumulated refinement [symbol] ₙ₊₁= [symbol] ₙ∪ [symbol] ₙ₊₁. The notation in FIG. 5 is simplified a little compared to the description for ease of understanding. Note that α₁=αᵢ_{ₙ}_{^{k}}(j₁), α₂=αᵢ_{ₙ}_{^{k}}(j₂), Bₚ=Bⱼ_{₁}, B_{q}=Bⱼ_{₂}.

### DETAILED DESCRIPTION

Mathematical background B-spline basis

A B-spline curve is a piecewise polynomial represented using a B-spline basis. A B-spline basis is composed of B-spline basis functions B_{i,t,d}(x), i=1, . . . , n, where:
d≧0 is the polynomial degree
n≧d+1, is number of basis functions

The knot sequence t={tᵢ}ᵢ₌₁^{n+d+1} describe the piecewise polynomial structure and the continuity between adjacent polynomial segments. If the value in the knot vector is repeated m times, then the piecewise polynomial at that value has continuity d−m. The elements of the knot sequence are real numbers that satisfies tᵢ≦tᵢ₊₁ with tᵢ<t_{i+d+1}. The last condition ensures that at most d+1 can be equal and allows that for a given knot value the continuity can vary from C⁻¹, . . . , C^{d-1}. (Here C⁻¹ means discontinuity in the function, C⁰ means contituity iof value, C⁻¹ means contuity of value and tangent, and C^{d-1} means continiuti of all derivative of order less than d.) The values and any order derivative of B-spline basis functions can be calculated using algorithms such as the Cox de Boor algorithm. It should be noted that the B-spline basis function B_{i,t,d}(x)=0 for x<tᵢ and t_{i+d+1}<x, and B_{i,t,d}(x)≧0 for tᵢ≦x≦t_{i+d+1}. The part of the domain where the B-spline basis function is different from zero is denoted the support of the B-spline basis function.

The B-spline basis is also partition of unity Σᵢ₌₁ⁿcᵢB_{i,t,d}(x)=1, for t_{d+1}≦x≦tₙ₊₁.

### Mathematical Background B-Spline Curve

A B-spline curve is defined by assigning a coefficient, often referred to as a vertex, to each B-spline basis function ƒ(x)=Σᵢ₌₁ⁿcᵢB_{i,t,d}(x). The partition of unity properties ensures that the curve is a convex combination of the coefficients/vertices cᵢ. This gives the coefficients a geometric interpretation. The coefficients define a polyline referred to as the vertices of the B-spline curve.

### Mathematical Background Tensor Product B-Spline Surface

A B-spline surface is defined by using two B-spline basis functions one in the x direction and one in the y-direction ƒ(x,y)=Σᵢ₌₁ⁿ^{₁}Σⱼ₌₁ⁿ^{₂}cᵢB_{i,t}_{₁}_{,d}_{₁}(x) B_{i,t}_{₂}_{,d}_{₂}(y). The partition of unity property ensures that the surface is a convex combination of the coefficients/vertices c_{i,j}. The vertices defines a grid of coefficients, this grid is often referred to as the grid of vertices of the B-spline surface.

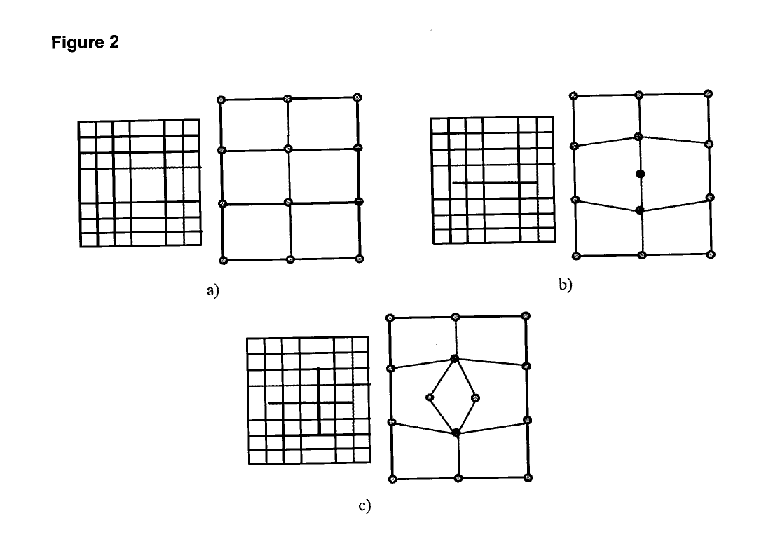

A tensor product B-spline is an organization of 2-variate polynomial patches in a grid as shown in FIG. 2a to the left, and with a regular grid of control vertices as shown in FIG. 2a to the right. The points in the grid can be moved around to give a model shape. In FIG. 2a to the right we have chosen to assign regular grid values to the vertices to just show the structure of the grid.

### One-Level Coding of the Refinement in the Spline Space

Our innovation combines the best from the approaches of B-splines, hierarical B-splines while providing a one-level coding, symmetric behavior and guarantee of linear independency. The idea is to build the refinement from compositions of minimal footprint refinement operations, i.e. the insertion of a knot value in one parameter direction in one tensor product B-spline basis function. This may be performed for one parameter direction in one tensor product B-spline basis function at a time, or simultaneously by performing the computation for each parameter direction and tensor product B-spline basis function in parallel in a computer system.

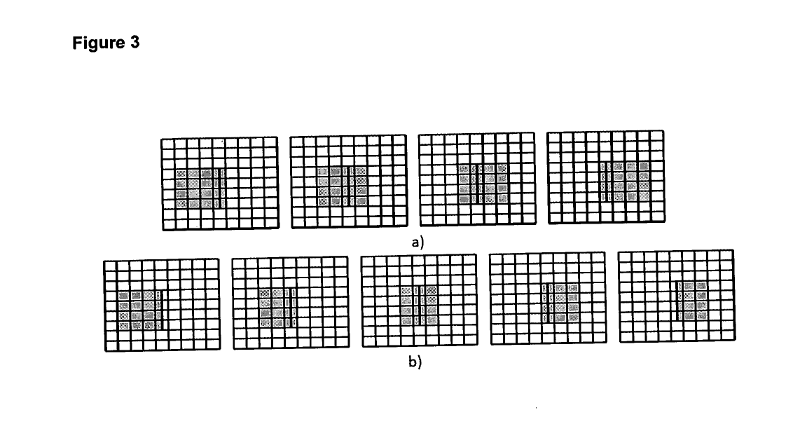

However, the insertion of a knot value in one parameter direction in one tensor product B-spline basis function does not only affect the one basis function. It affects all basis functions that have a width matching the four cells spanned by the knot line segment as illustrated in FIG. 3a for 2-variate splines.

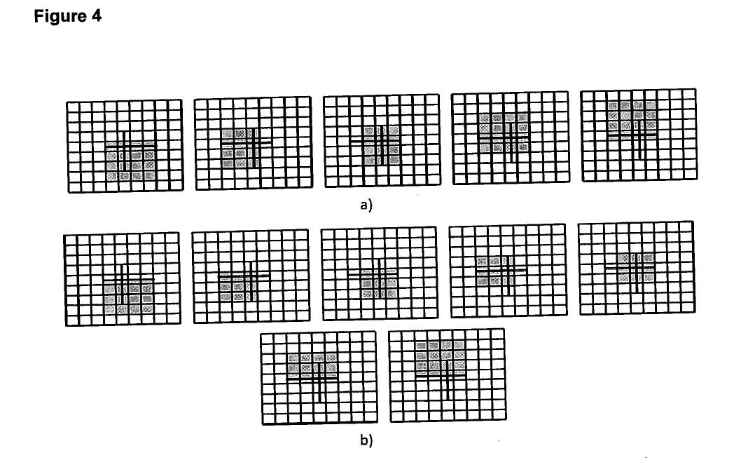

FIG. 3 illustrates such an operation on a bi-cubic surface with single knots. We insert a knot line segment spanning four cells in the grid. A bi-cubic B-spline basis function is described by a 5×5 regular grid of knot lines, At most four of the knot lines in each parameter direction can coincide. In FIG. 3 all knot lines are unique, e.g., there is no coincidence. The refinement thus has to span four cells in the grid to be valid. In FIG. 4a) we insert an additional knot line segment, now in the second parameter direction of the grid. This knot line segment span a width of 5 cells. FIG. 4a) shows the basis functions (dark area) from FIG. 3b) split by the new knot line segment, while FIG. 4b) shows the basis functions (dark area) resulting from this second splitting operation.

### Handling Local Knots of Tensor Product B-Spline Basis

As all tensor product B-spline basis functions describing the LR-spline can have individual sequences of knots from the knot vectors the traditional description of B-spline basis functions is not sufficient. The traditional description for a B-spline basis function
B_{i,d,t}(x)=B(x|tᵢ, . . . , t_{i+d+1}), where d is the degree, and t is the knot sequence. The knots used are consecutive and thus they can be identified just by one index.

For LR-splines we select knot values from a predefined knot vector t with increasing values tᵢ≦tᵢ₊₁, and thus the knots selected are explicitly listed by their position in the knot vector t. This is done by introducing an index vector i to selecting knots from t.

B_{i,d,t}(x)=B(x|t(i(0)), . . . , t(i(d+1))).

We assume that the components of i are ordered such that i(0)< . . . <i(d+1). B_{i,d,t}(x) of degree d is defined by an increasing sequence of knot values {t(i(i): 0≦i≦d+ [symbol] t(i(0))<t(i(d+1))}. The difference from the traditional notation for B-splines is that we express the indices i of the knots selected from t for each B-spline basis explicitly.

This change of notation allows a more flexible selection of knot values from the knot vector t than the traditional notation.

### Spaces and Coordinate Systems

In the following [symbol] denotes the l-dimensional real space, while [symbol] ^{l} denotes the l-dimensional projective space. The coordinate systems used are the global coordinate systems. However, implementation on computers can possibly employ local coordinate systems when feasible. The coefficients of the functions represented are either in [symbol] ^{l} or in [symbol] ^{l}, l>0. The use of projective spaces [symbol] ^{l} opens up for rational LR-splines thus including NURBS, (NonUniform Rational B-splines) used in CAD and isogeometric analysis as a specialization.

### Univariate LR-Spline Functions and Univariate B-Spline Basis Functions

A univariate LR-spline basis function ƒ: [symbol] → [symbol] ^{l}, or alternatively is ƒ: [symbol] → [symbol] ^{l}, l≧1 is described by

$$f ( x ) = {\sum }_{i ∈ 𝒥} {c}_{i} {γ}_{i} {V}_{i} ( x ) , with {c}_{i} ∈ {l}^{} , i ∈ , or {c}_{i} ∈ {l}^{} , l \geq 1.$$

Here d is the polynomial degree, [symbol] is an index set, Bᵢ(x)=B_{i,t,d}(x), and γᵢ are weights used for scaling the basis to be a partition of unity. In the case the LR-spline basis is a tensor product B-spline basis the weights all has value 1. The provision that cᵢε [symbol] ^{l}, i ε [symbol] , or cᵢε [symbol] ^{l}, i ε [symbol] for l≧1 ensures that both rational and nonrational spline curves are included, and that we include the NURBS curve from Computer Aided Design.

When ƒ(x) is a B-spline represented function following the normal conventions for selection of knots then [symbol] ={(i, . . . , i+d+1):1≦i≦N}, with n the number of basis functions.

### Bivariate LR-Spline Functions

A bivariate LR-spline basis function ƒ: [symbol] ²→ [symbol] ^{l}, or alternatively ƒ: [symbol] ²→ [symbol] ^{l}, l≧1 is described by

$$f ( x , y ) = {\sum }_{( {i}_{1} , {i}_{2} ) ∈ 𝒥} {c}_{{i}_{1} , {i}_{2}} {γ}_{{i}_{1} , {i}_{2}} {B}_{{i}_{1} , {i}_{2}} ( x , y ) , \\ with$$

$${c}_{{i}_{1} , {i}_{2}} ∈ {l}^{} , ( {i}_{1} , {i}_{2} ) ∈ , \\ or$$

$${c}_{{i}_{1} , {i}_{2}} ∈ {l}^{} , ( {i}_{1} , {i}_{2} ) ∈ 𝒥 , l \geq 1.$$

Here d₁ and d₂ are polynomial degrees, Bᵢ_{₁}_{,i}_{₂}(x,y)=Bᵢ_{₁}_{,d}_{₁}_{,t}_{₁}(x) Bᵢ_{₂}_{,d}_{₂}_{,t}_{₂}(y), [symbol] is an index set, and γᵢ_{₁}_{,i}_{₂} are weights used for scaling the basis to be a partition of unity. In the case the LR-spline basis is a tensor product B-spline basis the weights all has value 1. The provision cᵢ_{₁}_{,i}_{₂}ε [symbol] ^{l}, (i₁, i₂)ε [symbol] , or, cᵢ_{₁}_{,i}_{₂}ε [symbol] ^{l}, (i₁, i₂)ε [symbol] for l>1 ensures that both rational and nonrational spline surfaces are included, and that we include the NURBS surfaces from Computer Aided Design. If ƒ(x,y) is a B-spline represented function following the normal conventions for selection of knots for each B-spline basis function then [symbol] ={((iᵢ, . . . , i₁+d₁+1), (i₂, . . . , i₂+d₂+1):1≦i₁≦N₁ [symbol] ≦i₂≦N₂}, and γᵢ_{₁}_{,i}_{₂}=1, with N₁×N₂ the number of basis functions, giving

$$f ( x , y ) = {\sum }_{( {i}_{1} , {i}_{2} ) ∈ 𝒥} {c}_{{i}_{1} , {i}_{2}} {γ}_{{i}_{2} , {i}_{2}} {B}_{{i}_{1} , {i}_{2}} ( x , y ) = {\sum }_{i = 1}^{{N}_{1}} {\sum }_{j = 1}^{{N}_{2}} {c}_{i , j} {B}_{i , {d}_{1}} ( x ) {B}_{j , {d}_{2}} ( y ) .$$

### Trivariate LR-Spline Functions

A trivariate LR-spline basis function ƒ: [symbol] ³→ [symbol] ^{l}, or alternatively ƒ: [symbol] ³→ [symbol] ^{l}, l≧1 is described by

$$f ( x , y , z ) = {\sum }_{( {i}_{1} , {i}_{2} , {i}_{3} ) ∈ 𝒥} {c}_{{i}_{1} , {i}_{2} , {i}_{3}} {γ}_{{i}_{1} , {i}_{2} , {i}_{3}} {B}_{{i}_{1} , {i}_{2} , {i}_{3}} ( x , y , z ) ,$$

with cᵢ_{₁}_{,i} _{₂}ε [symbol] ^{l}, (i₁, i₂)ε [symbol] , or cᵢ_{₁}_{,i} _{₂} [symbol] ^{l}, (i₁, i₂)ε [symbol] , l≧1. Here d₁, d₂ and d₃ are the polynomial degrees, [symbol] is an index set, Bᵢ_{₁}_{,i}_{₂}_{,i}_{₃} (x,y,z)=Bᵢ_{₁}_{,d}_{₁}_{,t}_{₁}(x)Bᵢ_{₂}_{,d}_{₂}_{,t}_{₂}(y)Bᵢ_{₃}_{,d}_{₃}_{,t}_{₃}(z), and γᵢ_{₁}_{,i}_{₂}_{,i}_{₃} are weights used for scaling the basis to be a partition of unity. In the case the LR-spline basis is a tensor product B-spline basis the weights all have value 1. The provision that cᵢ_{₁}_{,i}_{₂}_{,i}_{₃}ε [symbol] ^{l}, (i₁, i₂, i₃)ε [symbol] or, or cᵢ_{₁}_{,i}_{₂}_{,i}_{₃}ε [symbol] ^{l}, (i₁, i₂, i₃)ε [symbol] for l≧1 ensures that both rational and nonrational spline volumes are included, and that we include the NURBS from Computer Aided Design. If ƒ(x,y,z) is a B-spline represented function following the normal conventions for selection of knots for each B-spline basis function then [symbol] ={((i₁, . . . , i₁+d₁+1), (i₂, . . . , i₂+d₂+1), (i₃, . . . , i₃+d₃+1)):1≦iⱼ≦Nⱼ [symbol] 1≦j≦3}, and γᵢ_{₁}_{,i}_{₂}_{,i}_{₃}=1, giving

$$\begin{matrix}f ( x , y , z ) = {\sum }_{( {i}_{1} , {i}_{2} , {i}_{3} ) ∈ 𝒥} {c}_{{i}_{1} , {i}_{2} , {i}_{3}} {γ}_{{i}_{1} , {i}_{2} , {i}_{3}} {B}_{{i}_{1} , {i}_{2} , {i}_{3}} ( x , y , z ) \\ = {\sum }_{i = 1}^{{N}_{1}} {\sum }_{j = 1}^{{N}_{2}} {\sum }_{k = 1}^{{N}_{3}} {c}_{i , j , k} {B}_{i , {d}_{1}} ( x ) {B}_{j , {d}_{2}} ( y ) {B}_{k , {d}_{3}} ( y ) .\end{matrix}$$

### R-Variate LR-Spline Functions

A r-variate LR-spline basis function ƒ: [symbol] ^{r}→ [symbol] ^{l}, or alternatively ƒ: [symbol] ^{r}→ [symbol] ^{l}, l≧1 is described by

$$f ( {x}_{1} , … , {x}_{r} ) = {\sum }_{( {i}_{1} , … , {i}_{r} ) ∈ 𝒥} {c}_{{i}_{1} , … , {i}_{r}} {γ}_{{i}_{1} , … , {i}_{r}} {B}_{{i}_{1} , … , {i}_{r}} ( {x}_{1} , … , {x}_{r} ) ,$$

with cᵢ_{₁}_{, . . . ,i}_{ᵣ}ε [symbol] ^{l}, (i₁, . . . , iᵣ)ε [symbol] , or cᵢ_{₁}_{, . . . ,i}_{ᵣ}ε [symbol] ^{l}, (i₁, . . . , iᵣ)ε [symbol] l≧1. Here d₁, . . . , dᵣ are the polynomial degrees, [symbol] is an index set, Bᵢ_{₁}_{, . . . ,i}_{ᵣ} (x₁, . . . , xᵣ)=Bᵢ_{₁}_{,d}_{₁}_{,t}_{₁}(x₁)Bᵢ_{₂}_{,d}_{₂}_{,t}_{₂}(x₂) . . . Bᵢ_{ᵣ}_{,d}_{ᵣ}_{,t}_{ᵣ}(xₙ), and γᵢ_{₁}_{, . . . ,i}_{ᵣ} are weights used for scaling the basis to be a partition of unity. In the case the LR-spline basis is a tensor product B-spline basis the weight all have value 1. The provision that cᵢ_{₁}_{, . . . ,i}_{ᵣ}ε [symbol] ^{l}, (i₁, . . . , iᵣ)ε [symbol] , or, cᵢ_{₁}_{, . . . ,i}_{ᵣ}ε [symbol] ^{l}, (i₁, . . . , iᵣ)ε [symbol] for l≧1 ensures that both rational and nonrational spline volumes are included. However, the number of subscripts are many in this notation, so we will introduce a vector for vectors of subscripts

i=(i₁, . . . ,iᵣ).

This allows us to make a very compact description of the LR-spline as

$$f ( x ) = {\sum }_{i ∈ 𝒥} {c}_{i} {γ}_{i} {B}_{i} ( x ) ,$$

with cᵢε [symbol] ^{l}, iε [symbol] ^{l}, or cᵢε [symbol] ^{l}, iε [symbol] , l≧1. This description looks similar to the univariate LR-spline functions and B-spline functions, but here i is a vector of vectors with indices selecting knot values. Thus we have a very compact notation for presenting the innovation.

We note that for each index vector iε [symbol] we have a 3-tupple of coefficients; the coefficient cᵢ, weight γ and the index i identifying the basis function by identifying knots in the knot vectors t₁ . . . , tᵣ. As the vectors t₁, . . . , tᵣ are used at all levels of refinement the LR-spline can be represented by the set

Λ={(cᵢ,γᵢ,i)|iε [symbol] }.

### Local Refinement an LR-Splines

To make the structure of the spline space of the LR-spline as easy to comprehend as possible, the basis of the spline space of the LR-spline is represented by tensor product B-spline basis functions with minimal support. We will do this by performing all subdivision immediately when a spatial refinement is specified. (By immediately is meant before the next computation is made, and not necessarily immediately after in time.) In principle some subdivision can be postponed, but then it is not simple to decide when the basis is linearly independent if the basis is not made to have minimal support basis functions.

### Refinement of a Tensor Product B-Spline Basis Functions by Knot Insertion

For curves LR-splines is the same as B-splines and gives little advantages. However, for spline surfaces and higher dimensional tensor product splines manifolds LR-splines allow to selectively specify a local refinement. The main advantage of this approach is a very compact coding of local refinements of spline spaces, and adaptive model refinement with a minimal footprint. This provides a method requiring significantly less computational performance. The specification of the spatial refinement for the univariate, bivariate, trivariate and r-variate cases are described by:
Univariate case: Insertion of a knot value. This is specified by an index 1 into the knot sequence t giving the knot value t(l). This is similar to traditional refinement of univariate B-spline represented functions. The knot value t(l) specifies the refinement to be performed.
Bivariate case: Insertion of an axis parallel knot line segment. This is specified by two tuples of indices (l_{1,min}, l_{2,min}) and (l_{1,max}, l_{2,max}) that satisfies that either l_{1,min}=l_{1,max} [symbol] l_{2,min}<l_{2,max} or l_{1,min}<l_{1,max} [symbol] l_{2,min}=l_{2,max}. This then identifies the knot line segment as follows:
   1. Case k=l_{1,min}=l_{1,max}: The straight line between (t₁(k), t₂(l_{2,min})) and (t₁(k), t₂(l_{2,max})). The refinement to be performed is the insertion of the knot value t₁(k) in the first parameter direction in the support of tensor product B-spline basis functions identified by the refinement specification.
   2. Case k=l_{2,min}=l_{2,max}: The straight line between (t₁(l_{1,min}), t₂(k)) and (t₁(l_{1,max}), t₂(k)). The refinement to be performed is the insertion of the knot value t₂(k) in the second parameter direction in the support of tensor product B-spline basis functions identified by the refinement specification.
This is novel compared to the specification of the refinement of a bivariate tensor product B-spline functions where a refinement is an axis parallel infinite line in the parameter domain.
Trivariate case: Insertion of an axis parallel rectangle. This is specified by two tuples of indices (l_{1,min}, l_{2,min}, l_{3,min}) and (l_{1,max}, l_{2,max}, l_{3,max}) that satisfies one of the three following conditions
   3. l_{1,min}=l_{1,max} [symbol] l_{2,min}<l_{2,max} [symbol] l_{3,min}<l_{3,max}
   4. l_{1,min}<l_{1,max} [symbol] l_{2,min}=l_{2,max} [symbol] l_{1,min}<l_{3,max}
   5. l_{1,min}<l_{1,max} [symbol] l_{2,min}<l_{2,max} [symbol] l_{3,min}=l_{3,max}
This then identifies the knot rectangles as follows:
   1. Case k=l_{1,min}=l_{1,max}: The axes parallel rectangle (t₁(k),t₂(l_{2,min}),t₃(l_{3,min})) and (t₁(k),t₂(l_{2,max}), t₃(l_{3,min})). The refinement to be performed is the insertion of the knot value t₁(k) in the first parameter direction in the support of tensor product B-spline basis functions identified by the refinement specification.
   2. Case k=l_{2,min}=l_{2,max}: The axes parallel rectangle (t₁(l_{1,min}), t₂(k),t₃(l_{3,min})) and (t₁(l_{1,max}), t₂(k),t₃(l_{3,max})). The refinement to be performed is the insertion of the knot value t₂(k) in the second parameter direction in the support of tensor product B-spline basis functions identified by the refinement specification.
   3. Case k=l_{3,min}=l_{3,max}: The axes parallel rectangle (t₁(l_{1,min}), t₂(l_{2,min}), t₃(k)) and (t₁(l_{1,max}), t₂(l_{2,max}), t₃(k)). The refinement to be performed is the insertion of the knot value t₃(k) in the third parameter direction in the support of tensor product B-spline basis functions identified by the refinement specification.
This is novel compared to the specification of the refinement of a trivariate tensor product B-spline functions where a refinement is an axis parallel infinite plane in the parameter domain.
r-variate case: Insertion of an axes parallel hyper-rectangle degenerate in one dimension. This is specified by two r-tuples of indices (l_{1,min}, . . . , l_{r,min}) and (l_{1,max}, . . . , l_{r,max}) that satisfies for j, 1≦j≦r

l_{j,min}=l_{j,max} [symbol] (l_{i,min}<l_{i,max},i≠j).
This then identifies the axes parallel degenerate hyper rectangle as follows:
   k=l_{j,min}=l_{j,max}: The axis parallel degenerate hyper-rectangle between
   (t₁(l_{1,min}), . . . , tⱼ₋₁(l_{j-1,min}),tⱼ(k),tⱼ₊₁(l_{j+,min}), . . . , tᵣ(l_{r,min})) and
   (t₁(l_{1,max}), . . . , tⱼ₋₁(l_{j-1,max}),tⱼ(k),tⱼ₊₁(l_{j+,max}), . . . , tᵣ(l_{r,max})).
The two r-tuples of real values thus defines the external corners of the axis parallel hyper rectangle. The refinement to be performed is the insertion of the knot value tⱼ(k) in the j-th parameter direction in the support of tensor product B-spline basis functions identified by the refinement specification.

This is novel compared to the specification of the refinement of a r-variate tensor product B-spline functions where a refinement is an infinit axis parallel hyperplane in the parameter domain.

We will later on use what we call a refinement specification. This is a set [symbol] of axis parallel degenerate hyper rectangles of the type above. The variable in which we have the degenerate dimension can be different in the same refinement specification [symbol] .

### Handling Knot Multiplicity

In the above refinement specification the refinement is specified in index space. When using actual knot values multiplicity of knot values might render a refinement invalid. E.g., if tⱼ(iⱼ(0))= . . . =tⱼ(iⱼ(dⱼ+1)), and we insert a knot value with index k, where iⱼ(0)<k<iⱼ(dⱼ), then the multiplicity of the knot value tⱼ(iⱼ(0)) will be d₁+2 and the resulting subdivision will create degenerate B-spline basis functions. Such degenerate basis functions will have to be discarded, although the refinement is legal as seen from index space. This situation will arise if the multiplicity of knots in the knot sequence is higher than the degree plus two. This can happen if we combine spatial refinement (h-refinement) and local degree elevation (p-refinement) when we adapt the knot sequence to the higher degree. Local degree elevation will be described later.

### Example Local Refinement Bivariate Case

In the following we will illustrate by an example on a spline spaces spanned by bi-variate tensor product B-spline basis functions. A typical example of the use of such a spline space is the representation of NURBS surfaces in CAD by a tensor product B-splines space. However, the innovation is applicable for spline spaces spanned by higher dimensional tensor product B-spline basis functions, as well as all spline space that can be spanned by basis functions satisfying the partition of unity property.

In the following we assume that all knot lines and knot lines segments have multiplicity one to simplify the description. FIG. 2a) shows the knot lines of a is bicubic spline space and the corresponding structure of control vertices. Each of the bicubic B-spline basis function has a support of 4×4 cells, thus described by 5 consecutive knot values in each parameter direction. The control vertices are described by the average of the three internal knots of each basis function in both parameter directions. These points are denoted the Greville points. Note that both the lines and the Greville points have a regular grid structure.

In FIG. 2b) we illustrate the spatial refinement in the second parameter direction by insertion of a minimal knot line segment. As a spatial refinement has to refine at least one basis function to be valid, it has to span the width of the support of the tensor product B-spline basis function to take effect. If the bi-degree of the tensor product B-spline basis function is (d₁,d₂), the basis function will span (d₁+1)×(d₂+1) knot cells. Consequently in the bicubic case the knot line segment has to span four cells. We see that new control vertex is inserted, T-splines behave similarly when one vertex is inserted.

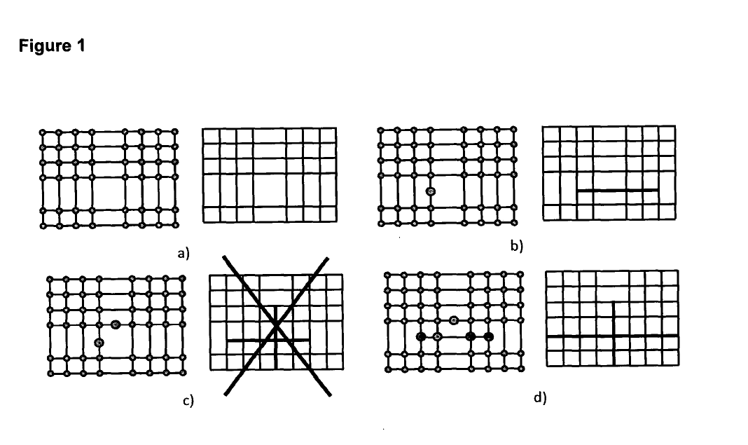

In FIG. 2c) we insert a knot line segment in the first parameter direction. The consequence is that the vertex generated in the first refinement shown in FIG. 2b is split in two. Here we see a major difference to T-splines where three extra control vertices are generated, and the first knot line inserted has to be extended into three extra cells (FIG. 1d). In FIG. 2c no extra vertices are created. This illustrates that in the present innovation the footprint of overlapping refinements is much smaller than for T-splines.

### Local Refinement of an R-Variate LR-Splines

The refinement of LR-splines can be addressed at three levels:
1. Spline Space Level. The refinement starts from a Source Spline Space [symbol] ₀ (which will be a tensor product B-spline space), that will be refined by successive spatial refinement specifications. [symbol] ₀ is described by its tensor product knot structure. The refinement is made by a sequence of spline spaces [symbol] ₀⊂ [symbol] ₁⊂ . . . ⊂ [symbol] ₙ, with a corresponding sequence of refinement specifications [symbol] ₁⊂ . . . ⊂ [symbol] ₙ. Each refinement specification [symbol] ⱼ, j=1, 2, . . . contains pairs of r-tuples describing the degenerate axis parallel hyper rectangles defining the refinement from [symbol] ₙ₋₁ to [symbol] ₙ. The n-th level spline space [symbol] ₙ is described relative to the source splines space [symbol] ₀ by the accumulated refinement specification [symbol] ₁= [symbol] ₁⊂ . . . ⊂ [symbol] ₙ.
2. Basis function level. At this level we decide the basis functions to use for describing the spline space of the LR-spline. Rather than use tensor product B-spline basis functions, we use scaled tensor product B-spline basis functions as this allows us to make a basis that is a partition of unity without resorting to rational scaling as in T-splines. The description of the basis functions [symbol] ₙ is given by

[symbol]

ₙ={γᵢⁿBᵢ|γᵢⁿ>0,iε [symbol] ₙ}.

The index set [symbol] ₙ specifies how the knot vectors t₁ . . . , tᵣ is used to describe the piecewise polynomial structure of the spline space and the continuity between the different pieces. Note that we have introduced the refinement level n as a superscript on the weight, and below on the coefficients to cater for the possibility that the weight and coefficient of a specific basis function is modified when neighbouring basis functions are refined. The requirement γᵢⁿ>0, iε [symbol] ₙ ensures that all weights are positive, thus enforcing removal of basis functions with weight 0, and ensuring that the scaled tensor product B-spline basis functions are non-negative.

While the approach of tensor product B-spline bases automatically provides minimal support basis function, LR-splines subdivision will not always generate minimal support basis functions. A prior spatial refinement specification can be valid for the basis functions resulting from a refinement, while not being valid for the basis function being refined. Consequently, each new basis functions resulting from the refinement is checked to detect if some prior refinement specifications remains to be performed on the basis function. By doing this the LR-spline will be represented with basis functions having a minimal support as is the tradition for a tensor product B-spline bases. So if the refinements happen to create a tensor product B-spline space by refinement of a LR-spline space the basis will become the proper tensor product B-spline basis.
3. Spline function level. At this level coefficients {cᵢⁿ|iε [symbol] ₙ} of each basis function are added to represent a specific spline function. It should be noted that the coefficients can be in cᵢⁿ can be in [symbol] ^{l} or [symbol] , l>0.

$${f}_{n} ( x ) = {\sum }_{i ∈ {𝒥}_{n}} {c}_{i}^{n} {γ}_{i}^{n} {B}_{i} ( x ) .$$

### Local Refinement and Spline Spaces

The refinement starts from a source tensor product B-spline space [symbol] ₀. Assuming that we have already performed n-levels of refinement, we have a spline space [symbol] ₙ. The refinement has made a sequence of spline spaces [symbol] ₀⊂ [symbol] ₁⊂ . . . ⊂ [symbol] ₙ, with a sequence of refinement specifications [symbol] ₁, . . . [symbol] ₙ. Each refinement specification [symbol] ᵢ is a list of axes parallel degenarate hyperplanes in the domain of the spline spaces that distinguish [symbol] ᵢ from [symbol] ᵢ₋₁$. [symbol] ₙ can also be refined directly from [symbol] ₀ by employing the accumulated refinement specification [symbol] ₙ= [symbol] ₁⊂ . . . ⊂ [symbol] ₙ. As already discussed each of the degenerate hyper planes specified in a refinement specification ((l_{1,min}, . . . , l_{r,min}), (l_{1,max}, . . . , l_{r,max})) relays three important messages.
1. It gives the criteria for the selection of the tensor product B-spline basis functions to subdivided, by identifying tensor product B-spline basis functions which domain is split by the degenerate hyper plane.
2. The parameter direction j in which the hyperplane is degenerate, e.g., l_{j,min}=l_{j,max} provides information on the parameter direction in which to subdivide the selected B-spline basis functions.
3. The value k=l_{j,min}=l_{j,max} provides information of the knot value tⱼ(k) to use in the subdivision in parameter direction j of the tensor product B-spline basis functions identified by the refinement specification.

### Refinement and Weighted B-Spline Basis Functions

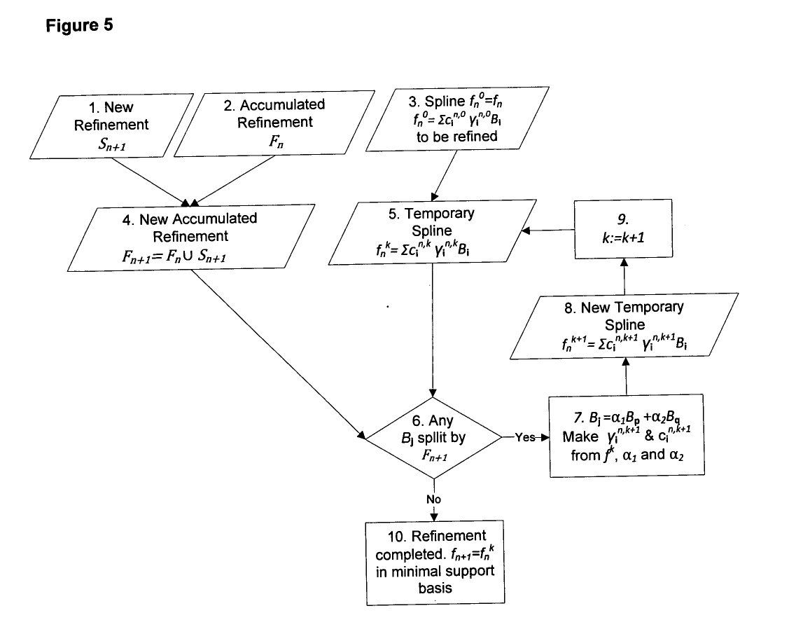

The refinement process is depicted as a flowchart in FIG. 5, and we will refer to FIG. 5 in the explanation below. The flowchart in FIG. 5 may be implemented as a computer program performing the refinement. The resulting refined model is may be displayed for a user as a visual image on a display device. It may therefore also be possible for the user to select the desired degree of local refinement based on the visual information provided in the displayed refined model. The refinement process may be run for selected regions of the model a desired number of times.

As already mentioned a spatial refinement specification can result in tensor product basis functions that do not have a minimal support. The minimal support property is important with respect to detecting interference between spatial refinement operations, for the geometric interpretation of the coefficients as a control grid, and for ensuring that the basis is linearly independent. While the first step in the refinement process is to perform a spatial refinement based on the new refinement specification [symbol] ₙ₊₁ (FIG. 5: 1. New refinement), the process of ensuring minimal support basis functions is based on the earlier accumulated spatial refinement specifications [symbol] ₙ (FIG. 5: 2. Accumulated refinement) that split the support of a refined basis function. Thus, by refining using [symbol] ₙ∪ [symbol] ₙ₊₁ (FIG. 5: 4. New Accumulated refinement), i.e. the union of the accumulated and the new refinement specifications, we do not need to distinguish between the two origins of refinement.

We will focus on the insertion of one single knot in one parameter direction inside the support of one tensor product B-spline basis function at a time. This is not computationally efficient, but makes the discussion simpler. Much efficiency may however be gained computationally by the insertion of multiple knot values simultaneously in multiple tensor product B-spline basis functions when feasible. Simultaneous computation in multiple tensor product B-spline basis functions may be achieved through parallelization on homogeneous and heterogeneous parallel computational resources, such a multi core CPUs and parallel computers.

Assuming that the basis function to be refined is denoted [symbol] ₙ^{k}, and the refinement to be performed is by the insertion of one knot value in one parameter direction in the support of Bᵢ_{ₙ}_{^{k}}, the refinement can be expressed (FIG. 5: 7)

Bᵢ_{ₙ}_{^{k}}=αᵢ_{ₙ}_{^{k}}(j₁)Bⱼ_{₁}+αᵢ_{ₙ}_{^{k}}(j₂)Bⱼ_{_{2.}}

where αᵢ_{ₙ}_{^{k}}(j₁)Bⱼ_{₁} and αᵢ_{ₙ}_{^{k}}(j₂)Bⱼ_{₂} are discrete B-spline values calculated by the Oslo is algorithm based on knot values before and after the knot insertion.

We now introduce an additional superscript/subscript k denoting the k insertion of a single knot value in the domain of a tensor product B-spline basis function in the process bringing us from [symbol] ₙ to [symbol] ₙ₊₁. In the following we will use this additional superscript/subscript extensively, and introduce the following spline spaces (FIG. 5: 3. Spline ƒₙ^{0=ƒ}ₙ).

[symbol]

ₙ= [symbol] ₙ⁰⊂ [symbol] ₙ¹⊂ . . . ⊂ [symbol] ₙ^{k}⊂ . . . = [symbol] ₙ₊₁.

Similarly we introduce a sequence of index sets [symbol] ₙ⁰, [symbol] ₙ¹ . . . , [symbol] ₙ^{k} corresponding to spline spaces above [symbol] ₙ⁰, . . . , [symbol] ₙ^{k}. where [symbol] ₙ⁰= [symbol] ₙ . . . . Each of these index sets [symbol] ₙ^{j}, j=0, . . . , k identifies the set of scaled tensor product basis functions

[symbol]

ₙ^{j}={γᵢ^{n,j}Bᵢ|γᵢ^{n,j}>0,iε [symbol] ₙ^{j}},

with [symbol] ₙ⁰= [symbol] ₙ, and γᵢ^{n,0}=γᵢⁿ,iε [symbol] ₙ^{j}= [symbol] ₙ.

Assuming that the basis function to be refined is denoted Bᵢ_{ₙ}_{^{k}}, and the refinement to be performed is by the insertion of one knot value in one parameter direction in the support of αᵢ_{ₙ}_{^{k}}, the refinement can be expressed

Bᵢ_{ₙ}_{^{k}}=αᵢ_{ₙ}_{^{k}}(j₁)Bⱼ_{₁}+αᵢ_{ₙ}_{^{k}}(j₂)Bⱼ_{_{2,}}

where αᵢ_{ₙ}_{^{k}}(j₁)Bⱼ_{₁} and αᵢ_{ₙ}_{^{k}}(j₂)Bⱼ_{₂} are discrete B-spline values calculated by the Oslo algorithm based on knot values before and after the knot insertion.

The knot refinement removes the basis function Bᵢ_{ₙ}_{^{k}} from [symbol] ₙ^{k}, and adds the two basis functions Bⱼ_{₁} and Bⱼ_{₂}. Thus [symbol] ₙ^{k+1} can be expressed

[symbol]

ₙ^{k+1}=( [symbol] ₙ^{k}{iₙ^{k}})∪{j₁,j₂}.

Most of the basis functions copied from [symbol] ₙ^{k} are unaffected by the knot insertion. However, the basis functions Bⱼ_{₁} and might already exist in [symbol] ₙ^{k}, so when calculating and updating weights (FIG. 5: 7. Make γᵢ^{n,k+1} and cᵢ^{n,k+1}) there are three cases

$${γ}_{j}^{n , k + 1} = \{ \begin{matrix}{γ}_{j}^{n , k} , & j ∈ {n}_{k + 1}^{} \backslash \{ {j}_{1} , {j}_{2} \} \\ {γ}_{j}^{n , k} + {α}_{{i}_{n}^{k}} ( j ) {γ}_{{i}_{n}^{k}}^{n , k} , & j ∈ {n}_{k + 1}^{} ⋂ \{ {j}_{1} , {j}_{2} \} \\ {α}_{{i}_{n}^{k}} ( j ) {γ}_{{i}_{n}^{k}}^{n , k} , & j ∈ \{ {j}_{1} , {j}_{2} \} \backslash {n .}_{k + 1}^{}\end{matrix}$$

The functions ƒₙ^{j}= [symbol] cᵢ^{n,j}γᵢ^{n,j}Bᵢ(x) (FIG. 5: 5. Temporary spline) expressed in the gradually refined bases [symbol] ₙ^{j}={γᵢ^{n,j}Bᵢ|γᵢ^{n,j}>0,iε [symbol] ₙ^{j}}, j=0, . . . ,k+1 also have their coefficients updated (FIG. 5: 7. Make γᵢ^{k+1} and cᵢ^{n,k+1}) when refined from [symbol] ₙ^{k} to [symbol] ₙ^{k+1}.

$${c}_{j}^{n , k + 1} = \{ \begin{matrix}{c}_{j}^{n , k} , & j ∈ {n}_{k + 1}^{} \backslash \{ {j}_{1} , {j}_{2} \} \\ \frac{{γ}_{j}^{n , k} {c}_{j}^{n , k} + {α}_{{i}_{n}^{k}} ( j ) {γ}_{{i}_{n}^{k}}^{n , k} {c}_{{i}_{n}^{k}}^{n , k}}{{γ}_{j}^{n , k + 1}} , & j ∈ {n}_{k + 1}^{} ⋂ \{ {j}_{1} , {j}_{2} \} \\ {c}_{{i}_{n}^{k}}^{n , k} , & j ∈ \{ {j}_{1} , {j}_{2} \} \backslash {n .}_{k + 1}^{}\end{matrix}$$

When we have made ƒₙ^{k+1}= [symbol] cᵢ^{n,k+1}γᵢ^{n,k+1}Bᵢ(x), (FIG. 5: 8. New Temporary spline), we have one of the following situations (FIG. 5: 6. Any Bⱼ split?):
1. At least one of the basis functions in [symbol] ₙ^{k+1} can be further subdivided by the union of accumulated refinement specification and the new refinement specification [symbol] ₙ∪ [symbol] ₙ₊₁. In this case we continue the refinement successively until no basis function can be further split by [symbol] ₙ∪ [symbol] ₙ₊₁. (FIG. 5: 9. k:=k+1)
2. No basis function can be further split by the refinement specification [symbol] ₙ∪ [symbol] ₙ₊₁. (FIG. 5: 10. Refinement completed) We have now made minimal support basis functions and set

$${n + 1}_{} = {n}_{k + 1}^{}$$

$${γ}_{j}^{n + 1} = {γ}_{j}^{n , k + 1} , j ∈ {n + 1}_{}$$

$${ℬ}_{n + 1} = \{ {γ}_{i}^{n + 1} {B}_{i} \vert {γ}_{i}^{n + 1} > 0 , i ∈ {n + 1}_{} \}$$

$${c}_{j}^{n + 1} = {c}_{j}^{n , k + 1} , j ∈ {n + 1}_{}$$

$${f}_{n + 1} = {\sum }_{i ∈ {𝒥}_{n + 1}} {c}_{i}^{n + 1} {γ}_{i}^{n + 1} {B}_{i} ( x ) .$$

The basis [symbol] ₙ₊₁ is partition of unity. Provided that the polynomial degrees in [symbol] ₙ₊₁ remains the same as in [symbol] ₀ and all degenerate basis functions are to removed (no basis function in [symbol] ₙ₊₁ have a degenerate support) then the basis functions in [symbol] ₙ₊₁ are linearly independent. Consequently we have made a new refined spline space suitable for modeling in a computer system.

In the above we have mentioned that the polynomial degrees in [symbol] ₙ₊₁ and [symbol] ₀ are the same, thus addressing spatial refinement (h-refinement). However, the LR-spline concept also opens up the possibility to locally increase the polynomial degree (h-refinement) of selections of basis functions, thus making the concept even more flexible for modeling. However, when doing this care has to be taken to ensure a linearly independent basis. A further h-refinement after degree elevation can result in linear dependency between basis functions of different degrees. For some uses, such as local refinement for CAD-type design or styling, this will not matter, for other uses such as interpolation linear independence is important.

The degree elevation can be done in one parameter direction in one basis function at the time. More intricate degree elevation can be broken into a sequence of such single basis functions, single parameter direction elevation steps.

The identification of which basis function to degree raise can be passed on spatial selection, or directly by identification by the indices set of the basis function. Let the basis function Bᵢ_{ₙ} be the basis function to be degree raised, and let the degree raising be by one degree from dᵣ to dᵣ₊₁ in parameter direction r of Bᵢ_{ₙ}. In this setting the degree of a basis function can be deducted from the index sets describing the knots used. The degree dᵣ in parameter direction r of a tensor product B-spline function is the length of the knot index vector in direction r minus two. Thus the notation already presented cover degree elevation. Bᵢ_{ₙ} can be expressed at a linear combination of dⱼ+2 basis function where the degree in parameter direction r is raised by one

$${B}_{{i}_{n}} = {\sum }_{j = 1}^{{d}_{j} + 2} {β}_{{i}_{n}} ( {j}_{j} ) {B}_{{j}_{j}} ,$$

Where βᵢ_{ₙ}(jⱼ), j=1, . . . , dⱼ are calculated, e.g., by the degree evaluation methods (Cohen, Lyche, Shumaker, Algorithms for degree-raising of splines, ACM Transactions on Graphics, Volume 4, Issue 3 (July 1985) Pages: 171-181).

So if [symbol] ₙ is the index set of the spline space [symbol] ₙ existing before the degree elevation then the index set after the elevation is [symbol] ₙ₊₁=( [symbol] ₙ\iₙ)∪{j₁, . . . , j_{d}_{ⱼ}₊₂}. The weight are calculated following similar steps as in spatial refinement

$${γ}_{j}^{n + 1} = \{ \begin{matrix}{γ}_{j}^{n} , & j ∈ \\ {γ}_{j}^{n} + {β}_{{i}_{n}} ( j ) {γ}_{{i}_{n}}^{n} , & j ∈ \\ {β}_{{i}_{n}} ( j ) {γ}_{{i}_{n}}^{n} , & j ∈ \{ {j}_{1} , … , {j}_{{d}_{j} + 2} \} \backslash {n + 1}_{}\end{matrix}$$

The coefficients also updated along the same lines

$${c}_{j}^{n + 1} = \{ \begin{matrix}{c}_{j}^{n} , & j ∈ \\ \frac{{γ}_{j}^{n} {c}_{j}^{n} + {β}_{{i}_{n}} ( j ) {γ}_{{i}_{n}}^{n} {c}_{{i}_{n}}^{n}}{{γ}_{j}^{n + 1}} , & j ∈ \\ {c}_{{i}_{n}}^{n} , & j ∈ \{ {j}_{1} , … , {j}_{{d}_{j} + 2} \} \backslash {n + 1}_{} .\end{matrix}$$

The LR-spline after degree elevation of a selected basis function is thus

$${f}_{n + 1}^{e} = {\sum }_{} {c}_{i}^{n + 1} {γ}_{i}^{n + 1} {B}_{i} ( x ) .$$

We have added a superscript e to indicate that there can be linear dependencies between basis functions of different degrees. The process of sorting out these linear dependencies will involve degree elevations of lower degree basis functions that can be linearly dependent on the higher degree basis functions, and will be fairly complicated if there are frequent variation of degrees between adjacent basis function. After this process the LR-spline function ƒₙ₊₁ described in a linearly independent basis can be made.

### 2 Application Areas for LR-Splines

The use of locally refined spline functions will be advantageous compared to tensor product B-splines for all sort of representation problems hampered by the regular grid structure of tensor product B-splines. As the locally refined spline functions model the spline space directly, the control of the spline space is much better than for T-splines. The T-spline theory is currently only developed for surfaces, although extensions to higher dimensions are discussed. The locally refined spline functions also avoid the challenge of large growth in coefficients encountered for some case when using T-splines.

LR-Splines are Aimed at Applications within the Following Areas:
Finite element Analysis and Isogeometric analyses by replacing NURBS, T-splines and traditional Finite elements for representation of geometry and the analysis models. As mentioned US 20090024370 describes the use of T-splines within isogeometric analysis. As the LR-Splines according to the present invention are more generic than T-splines and better scales to higher dimensional parametric manifolds they will be very well suited for isogeometric analysis. This will provide more compact and controlled representation than T-splines and NURBS representation, and more accurate solution of the analysis problem than traditional Finite Element representation. The approach is directly applicable to any dimension manifold, e.g. volumes in 3D or higher dimension, not only surface in 3D for which T-splines are aimed at.
   1. Accurate modelling of the geometry to be analysed (LR-spline geometry element grid). The local refinement properties of LR-spline will allow the model to be more compact than B-spline models
   2. Use of the spline space of the LR-spline element grid as the element grid of the analysis model. If more degrees of freedom are needed, then these can be locally added by further refinement of the LR-spline analysis grid, without any need for modifying the LR-spline geometry element grid.

Computer Aided Design for local modification of surfaces and stitching of adjacent surfaces. The present invention provides a more general approach than T-splines due to the direct modelling of the spline space thus introducing the required degrees of freedom where needed, Within CAD LR-splines opens up new approaches for surface modeling by exploiting local refinements. E.g., when lofting curves we no longer have to represent all curves lofted in the spline basis, we just need to insert enough knots to properly represent sequences of consecutive curves. For the approximation of offset surfaces much more compact surfaces can be found. When modeling surface into a network of patches then the local refinements of LR-splines will allow the surfaces to have opposite boundary curves with different knot vectors. LR-spline may also be extended to triangular patches.

Representation of models built from sampled and measured data. This can be models both from industrial production and models of the environment, e.g., terrain models, contour lines from maps, coverage maps for cellular phone base stations or measurement of physical properties and processes. The LR-Splines provide a more compact and flexible description method than current approaches within such modeling. The approach offers a compact one level coding of the coefficient of locally refined splines spaces where earlier approaches had to rely on hierarchical (multi resolution) representation structures. Approximation of measured points still has many open problems. Using tensor product B-spline representation, e.g., for approximation of measured surface points, is not straight forward as in many cases the distribution of points does not match the spatial distribution of degrees of freedom in the tensor product B-spline surface. The LR-Splines open the possibility to adapt the local refinement of basis functions to the actual point distribution and thus perform a better approximation. It also opens the possibility to try “knot interval” removal techniques for surfaces, where we locally try coarsening of the B-spline basis similar to what is done in the knot-removal techniques. The approach of locally refined spline functions B-spline functions is not only limited to surfaces in 3D, but can be used for locally refining tensor product refinement of manifold of higher order than two.
3D Animation for games and movies. The approach combines the watertightness of subdivision surfaces and the simplicity of NURBS representation and allows for dynamic modification of 3D shape and local shape features.
For the modeling of geological structures by splines by allowing the volumetric representation of the structures to adapt to the actual complexity of the geological shape.

Having described preferred embodiments of the invention it will be apparent to those skilled in the art that other embodiments incorporating the concepts may be used. These and other examples of the invention illustrated above are intended by way of example only and the actual scope of the invention is to be determined from the following claims.

1. Method for spatially refining a computer generated l-dimensional (l>0) model in a computing environment, the l-dimensional model representing physical or geometrical properties, and where the l-dimensional model is represented by tensor product B-splines basis functions and l-dimensional coefficients, where the l-dimensional coefficients are in real or projective space, and the tensor product B-splines basis functions are spanning an r-variate spline space (r>0) having a parameter domain, the method comprising:
a) inserting at least one axis parallel hyper rectangle degenerate in one dimension in said parameter domain, providing a splitting of a support of at least one of said tensor product B-spline basis functions;
b) computing refined tensor product B-spline basis functions by subdivision on said at least one tensor product B-splines basis functions whose support is split, using at least one knot value of the at least one axis parallel hyper rectangle; and
c) computing the resulting refined l-dimensional representation based on said refined tensor product B-spline basis functions.

2. Method according to claim 1, further comprising computing an accumulated refinement specification based on the refined tensor product B-spline basis functions.

3. Method according to claim 2, comprising performing further refining of said refined l-dimensional r-variate representation by computing further refined tensor product B-spline basis functions by performing the steps a), b) and c) on the resulting refined l-dimensional representation.

4. Method according to claim 3, comprising further subdivision of the refined tensor product B-spline basis functions by using the accumulated refinement specification for the refined basis functions which domain can be further refined by the accumulated refinement specification.

5. Method according to claim 1, wherein said axis parallel hyper rectangle with one dimension degenerate is defined by two r-tuples of real values defining external corners of the axis parallel hyper rectangle, (r>0).

6. Method according to claim 6, wherein said two r-tuples of real values are specified by predefined knot vectors in all r-parameter directions of said domain.

7. Method according to claim 1, further comprising performing degree elevation of selected tensor product B-spline basis function.

8. Method according to claim 1, comprising scaling the subdivided tensor product B-spline basis functions by accumulated weights providing a partition of unity basis.

9. Method according to claim 1, comprising rationally scaling the subdivided tensor product B-spline basis functions by dividing by a sum of all tensor product B spline basis functions to provide a partition of unity basis.
